(19) United States
(12) Patent Application Publication
(10) Pub. No.: US 2014/0004852 A1
(43) Pub. Date: Jan. 2, 2014

(54) TEST SUITE FOR A MOBILE DEVICE

(71) Applicants: Doron LEHMANN, Kfar Vradim (IL); Daniel Friedman, Beit-Shemesh (IL); Gilad Hazan, Holon (IL)

(72) Inventors: Doron LEHMANN, Kfar Vradim (IL); Daniel Friedman, Beit-Shemesh (IL); Gilad Hazan, Holon (IL)

(73) Assignee: SAP Portals Israel Ltd, Ra'anana (IL)

(21) Appl. No.: 13/539,448

(22) Filed: Jul. 1, 2012

(51) Int. Cl. H04W 24/00; H04W 88/02

(52) U.S. Cl. 455/425; 455/557

(57) ABSTRACT

A computerized method for testing a mobile device, comprising activating in a computer a program that accesses the mobile device via a mechanism that is at least partly installed in the mobile device, thereby conducting a test of the mobile device and consequently acquiring data related to a state of the mobile device, and providing the data related to a state of the mobile device to a storage device of a test management system, thereby updating the test management system, and an apparatus for performing the same.

### BACKGROUND

The present disclosure generally relates to testing a mobile device, and more specifically to remotely testing the mobile device.

Remotely accessing resources of mobile devices such as smartphones is known in the art. For example,

Mobile devices generally have, beyond processing capabilities, components that take part in the operation of the devices. For example, a touch-screen, lamp such as LED, a wireless modem, GPS receiver, accelerometer, as well as a battery,

Mobile devices are generally operated by an operating system, such as iOS (Apple Inc.) or Android (Google Inc.) or Windows Phone (Microsoft Inc.).

### SUMMARY

One exemplary embodiment of the disclosed subject matter is a computerized method for testing a mobile device, comprising activating in a computer a program that accesses the mobile device via a mechanism that is at least partly installed in the mobile device, thereby conducting a test of the mobile device and consequently acquiring data related to a state of the mobile device, and providing the data related to a state of the mobile device to a storage device of a test management system, thereby updating the test management system.

Another exemplary embodiment of the disclosed subject matter is a computerized apparatus for testing a mobile device, comprising a computer configured with a program for accessing the mobile device via a mechanism that is at least partly installed in the mobile device, thus facilitating to conduct a test of the mobile device and acquire data related to a state of the mobile device, and a storage device of a test management system linked to the computer, the storage device configured to receive the data related to a state of the mobile device and thereby to update the test management system.

In the context of some embodiments of the present disclosure, without limiting, a mobile device denotes a device that is generally a hand-held battery operated stand-alone device a having processor and storage and other internal elements or components, such as a port for Internet and/or a cellular communication transceiver, a touch-screen, as well as, at least optionally, an accelerometer, gyroscope, or a GPS receiver and/or other elements such as a sensor for battery level. For example, iPhone (Apple Inc.), iPad (Apple Inc.), Samsung Galaxy Tab (Samsung Electronics Co. Ltd.), Samsung Galaxy S2 (Samsung Electronics Co. Ltd.) or HTC Sensation (HTC Corporation) or any other such as device.

In the context of some embodiments of the present disclosure, without limiting, a ‘hybrid web container’ or ‘application container’ denotes a mechanism of software and/or hardware that can remotely access and/or control and/or interact with the software and/or components of a mobile device. For brevity without limiting, the hybrid web container or application container is referred to also a ‘probe’.

Generally, without limiting, the probe accesses the mobile device by an interface or interfaces or plug-in that are exposed or exported, for example, by API (application programming interface) or APIs.

The probe and/or part thereof may be a shelf product such as PhoneGap™ or Appspresso™ or, additionally or alternatively, may be custom built, or may be a combination of ready parts and custom parts.

Without limiting, the probe accesses the mobile device via an internet or web link, without precluding other methods carriers and/or protocols such as Bluetooth or WiFi or Zigbee.

In the context of some embodiments of the present disclosure, without limiting, a quality assurance suite, referred to also a ‘QA suite’, denotes one or more programs operating on one or more computers that interact with a computerized apparatus. For example, invoking and/or triggering operations on the computerized apparatus and/or monitoring and/or examining values of variables and/or progress of operations of the computerized apparatus and/or collecting information from the computerized apparatus.

For instance, the QA suite may invoke a procedure of the computerized apparatus and collect or retrieve results of the procedure, such as a resultant screen contents or a screen-shot (capture of a screen image or contents).

Generally, without limiting, the program or programs of the QA suite interacts, such as via a communication link, with a storage device and/or structure, such as a database, for storing data related to a test and results thereof, such as for subsequent retrieval and/or analysis.

In some cases, without limiting the QA suite comprises two components. One component is a test program or a set of programs, collectively referred to as a ‘test program’ that interacts with the computerized apparatus. Another component is storage, such as a database, for storing and retrieving information related to a test preformed by the test program and provided by the test program such as for analyzing a test and result thereof. In some cases, the storage is remotely linked with a computer that operates the test program.

Generally, without limiting, the test is conducted by a manual control and/or automatically by pre-set scenarios such as scripts, or a combination thereof.

In the context of some embodiments of the present disclosure, without limiting, referring to a test implies also obtaining and/or acquiring information, the information also referred to as result and/or results of the test.

In the context of the present disclosure, without limiting, the term ‘invoke’ implies also ‘activate’ and/or ‘call’.

In the context of the present disclosure, without limiting, the term interactable implies capable of interacting.

The terms cited above denote also inflections and conjugates thereof.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, and may not be repeatedly labeled and/or described.

Dimensions of components and features shown in the figures are chosen for convenience or clarity of presentation and are not necessarily shown to scale or true perspective. For convenience or clarity, some elements or structures are not shown or shown only partially and/or with different perspective or from different point of views.

References to previously presented elements are implied without necessarily further citing the drawing or description in which they appear.

FIG. 1A schematically illustrates two separate and disparate environments, one environment comprising a mobile device and the other environment comprising an at least one general purpose computer interacting with a database.

FIG. 1B schematically illustrates an at least one general purpose computer interacting with a database and interacting with a probe that further interacts with a mobile device, according to exemplary embodiments of the disclosed subject matter;

FIG. 1C schematically illustrates representative arrangement of components of FIG. 1B, according to exemplary embodiments of the disclosed subject matter; and

FIG. 2 outlines operations for integrating a QA suite with a mobile device, according to exemplary embodiments of the disclosed subject matter.

### DETAILED DESCRIPTION

One technical problem dealt by the disclosed subject matter is integrating testing of a mobile device with a separate and disparate QA suit.

One technical solution according to the disclosed subject matter is one or more computers operating a QA suite and employing a probe as an interface gateway to the mobile device, thereby enabling to access the mobile device and resources thereof.

Thus, in some embodiments, using the probe the QA suite can performs activities such as modify variables of the mobile device, acquire status of the mobile device and of parts thereof, trigger and/or simulate and/or monitor events of the mobile device such as incoming call or battery low state, examine and/or collect values of variables and/or other data such as content of the screen of the mobile device.

Data collected by accessing the mobile device and resources thereof is stored, optionally with other data such as test scenarios, for further retrieval such as for re-accessing or re-testing the mobile device or for analysis and/or altering the tests, for example, to improve the test reliability and/or coverage.

In some embodiments, the probe or at least a part thereof is installed in the mobile device and interacts with the QA suite by a communications link.

A potential technical effect of the disclosed subject matter is an integrated suite for performing activities in mobile devices environment, thus increasing the efficiency of a quality testing and assurance.

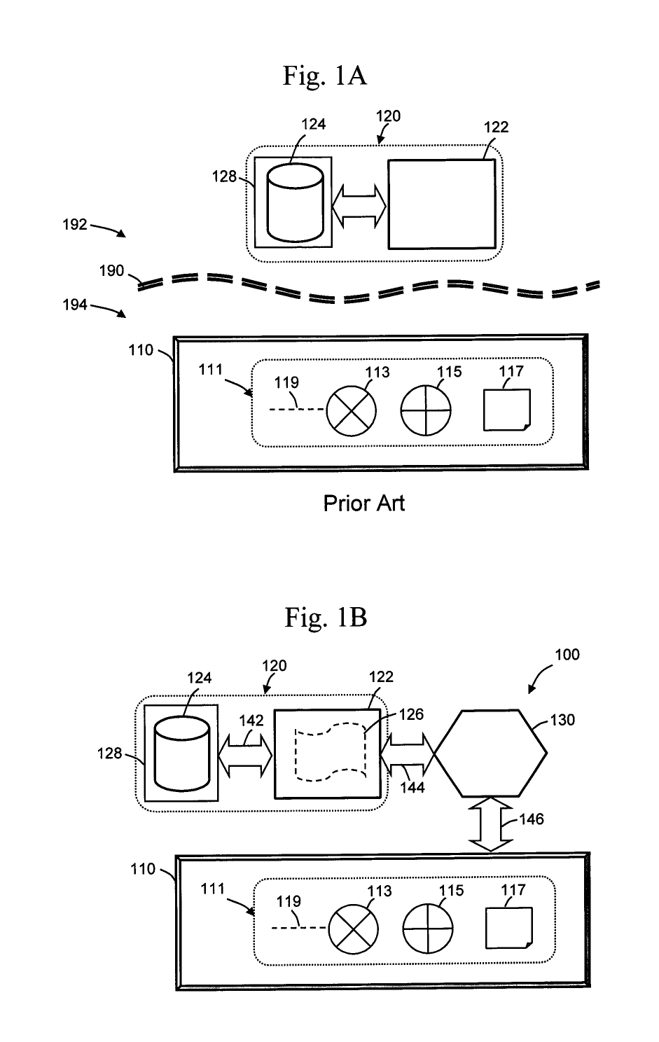

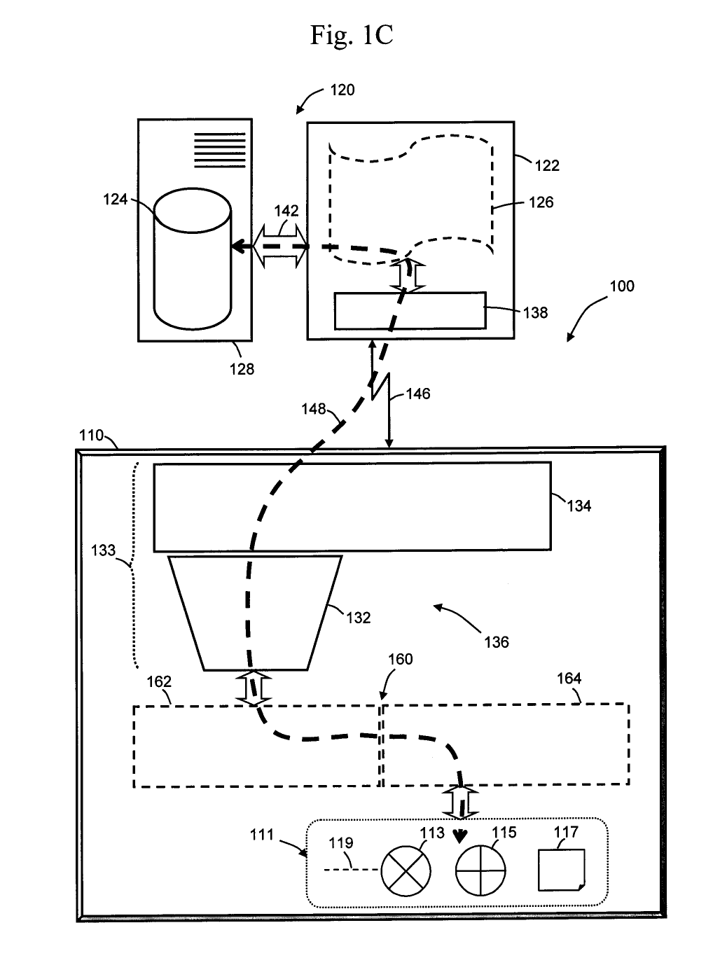

FIG. 1A schematically illustrates two separate and disparate environments as occurs or may occur in the art. One environment, denoted as environment 194, comprises a mobile device 110, where mobile device 110 is a stand alone device. A second environment, denoted as environment 192, comprises an at least one general purpose computer denoted as computer 122 interacting such as via a link with a storage denoted as database 124 in a computer denoted as storage computer 128, as illustrated by a double-arrow 142. In some embodiments, storage computer 128 is remotely linked with computer 122.

Computer 122 is configured to perform test on a computerized apparatus, where test data are retrievably stored in database 124. Computer 122 and database 124 in storage computer 128 are collectively denoted as QA suite 120.

Generally, in some embodiments, database 124 participates in a system for tests managements such as for storing and retrieving data for tests and results thereof, where in some embodiments, storage computer 128 is a server for providing services for storing, managing and delivering data for tests.

Optionally, in some embodiments, computer 122 and storage computer 128 are one and same computer or apparatus. Mobile device 110 comprises an at least one processor (not shown) and a memory (not shown), and further comprises components of elements collectively denoted as components 111. As illustrated schematically, components 111 comprises, for example, an accelerometer 113, a camera 115 and/or a contacts data structure 117 stored in a storage component. A dashed line 119 denotes that components 111 may comprise any number of components and types, where a component such as camera 115 may appear in a multiplicity, such as a front and back cameras.

QA suite 120 in environment 192 is separated from mobile device 110 in environment 194, as illustrated by a separator or a divider as a double-line 190, and thus QA suite 120 cannot perform tests on mobile device 110, as generally known in the art.

FIG. 1B schematically illustrates a system 100 comprising computer 122 interacting with database 124 and combined as QA suite 120, and interacting, as illustrated by a double-arrow 144, with a probe 130 that further interacts, as illustrated by a double-arrow 146, with mobile device 110, according to exemplary embodiments of the disclosed subject matter.

Probe 130 provides access to components 111 of mobile device 110, and exposes or provides indirectly such as a bridge for QA suite 120 to access components and variables and monitor events of mobile device 110, including, for example, to simulate and/or emulate conditions in mobile device 110 such as a telephone call or SMS incoming message or battery level or other events such a state of an accelerometer or capturing an image by a camera.

Executing a test program in computer 122, illustrated schematically as a test program 126, the program may control and/or interact with mobile device 110 via probe 130, thus integrating or combining QA suite 120 and test program 126 with mobile device 110; in other words or aspect, probe 130 operates as a junction and/or interface between QA suite 120 and mobile device 110.

FIG. 1C schematically illustrates representative arrangement of components of system 100, according to exemplary embodiments of the disclosed subject matter.

Mobile device 110 is schematically illustrated with an operating system 160 comprising a general purpose part 162 and a drivers part 164 for operating elements or components such as components 111.

At least a part of probe 130, denoted as a mobile part 136, as indicated by a dotted bracket 133, is installed in mobile device 110 and comprises a probe operating part 134, and a probe interfaces part 132 for components such as components 111, for example, as drivers or plug-ins or add-ons for and/or of operating system 160.

In some embodiments, probe 130 comprises a component denoted as a probe web part 138 residing and operating in computer 122 in conjunction, such as by APIs, with test program 126, where probe web part 138 and probe operating part 134 are configured to communicate therebetween, such as by TCP/IP or other medium and/or protocol.

Generally, without limiting, probe web part 136 is operable as a web application on computer 124. Optionally or alternatively, probe web part 138 is not a part of probe 130 and is a general purpose application or task, such as a web application or a script process. Optionally or alternatively, probe web part 138 is partly a part of probe 130 and partly a general purpose application.

Thus, operation of QA suite 120 is integrated with mobile device 110, where database 124, at least optionally, provides data to test program 126 for testing of mobile device 110, and subsequently test program 126 via probe 130 accesses or interacts with mobile device 110 and components thereof. Further, information of mobile device 110 and/or results of a test are passed back to database 124. A curved dashed line 148 schematically illustrates a virtual interaction between database 124 of QA suite 120 and mobile device 110 and components thereof such as components 111.

In some embodiments, storage computer 128 is a server optionally remotely linked with computer 122 and optionally linked with other apparatus and/or apparatuses. In some embodiments, storage computer 128 with database 124 provides tests management and/or bugs reporting services for mobile device 110 and, optionally, for other apparatuses.

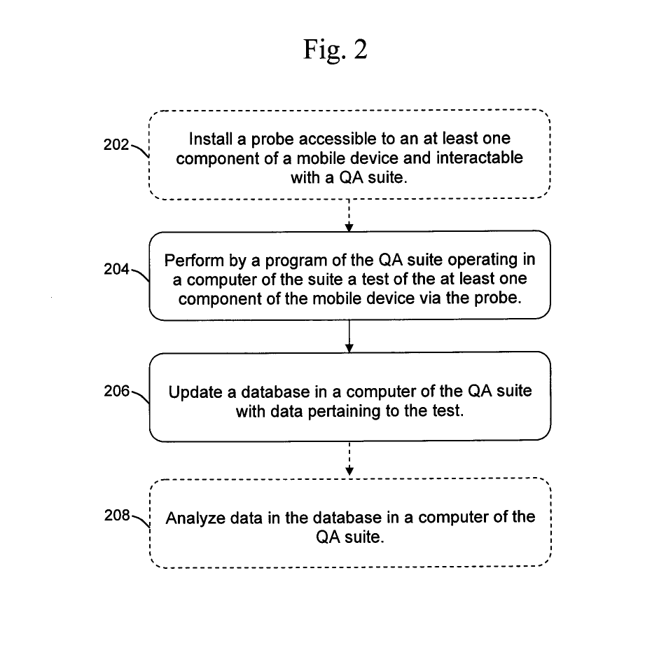

FIG. 2 outlines operations for integrating a QA suite with a mobile device, according to exemplary embodiments of the disclosed subject matter.

In operation 202 a probe as a hybrid web container or an application container, such as PhoneGap™ or Appspresso™ or AppFurnace™ or a custom probe, accessible to an at least one component of a mobile device and interactable with a QA suite is installed in the mobile device and, optionally or in some embodiments, at least partly in a computer of the QA suite.

It is noted that, in some embodiments, the probe is pre-installed and the installing operation is not a part of the method described herein.

In operation 204 a test of the at least one component of the mobile device is performed or carried out via the probe by a program of the QA suite operating in a computer of the QA suite.

Exemplary tests of a component of the mobile device comprise, but not limited to:
Operate a camera of the mobile device, optionally acquiring the image captured by the camera or a part of the image.
Capture a screen image of the mobile device, control a tilt of an accelerometer of the mobile device and/or emulate a tilt operation thereof and capture the resultant screen image of the mobile device to verify that the screen rotated or flipped responsive to the tilt operation and/or emulation.
Inject and/or emulate a GPS location and acquire the determined location of the mobile device such as by data therein and/or an image of a GPS application screen.
Set and/or emulate a low level of the battery of the mobile device and check response of the mobile device such as by an invoked application and/or screen image.
Emulate an incoming call and acquire caller ID as determined by the mobile device.
Emulate an incoming SMS a sending an SMS to the mobile device and acquire the text of the SMS as determined by the mobile device.
Operate a camera of the mobile device and invoke sending the captured image as multimedia message, optionally capturing the sent image.
Invoking a stored video in the mobile device and capturing the video.

Referring to emulating, without limiting, implies also simulating.

Similarly, other tests may or are carried out and results and/or responses thereof, such as events, are acquired and/or captured. For example, incoming mail or low receptions alert. In some embodiments, components of the mobile device comprise also a storage component and/or stored data structures, for example, a file, a contacts store of the mobile device, mail inbox, mail outbox, sent items box or a multimedia storage.

In some embodiments, the test may acquire or capture a state of the mobile device and/or components and/or parts thereof. The state may comprise values of variable and/or contestants and/or conditions and/or status and/or settings of parts and/or components of the mobile device. A state may apply for the whole device a part thereof or components thereof, so that a multiplicity of states can be acquired, for example, a state of an application, as state of an accelerometer, and so forth.

In some embodiments, a state and/or parts thereof is pre-defined or pre-stored, thus providing a multiplicity of states such as according to what is being or intended to be tested. In some embodiments, a state may be passed on or downloaded to the mobile device, thereby setting the mobile device in a specific state. A state is also referred to as a snapshot and can be obtained and further manipulated as an integral entity.

In some embodiments, a test comprises monitoring and/or collecting and/or acquiring activities of a user of the mobile device. For example, touch activities (sliding, tapping, gestures, etc.), orientation change (rotation or flipping) or button pressing such as volume adjustment or home button.

Acquiring or capturing data of the mobile device is generally, without limiting, facilitated by the operating system of the mobile device, such as operating system 160 of mobile device 110, and/or by auxiliary elements of the operating system such as drivers cooperating with the operating system, such as drivers in drivers part 164 of operating system 160 of mobile device 110.

Generally, in some embodiments and without limiting, a test involves testing an application in the mobile device, where the application interacts with one or more components of the mobile device. The application is either a custom application installed in the mobile device and/or a native application of the mobile device and/or a third party application and/or any combination thereof.

In some embodiments, the test mechanism involve a mechanism of interrupting an operation of the mobile device such as an application operating therein, thereby examining and/or obtaining values of variable and/or data constructs and/or state of components of the mobile device.

The test may be activated responsive to an operation of an operator of the QA suite. For example, by a mouse click on a rendered button such as arranged in a rendered menu, or picking such as by a mouse on an item of a rendered list in the test program, where, for example, the list is provided from the database of the QA suite.

In some embodiments, a test is carried out periodically responsive to an operation of the operator. Optionally or additionally, a test is scheduled for a later processing responsive to an operation of the operator.

In operation 206 a database in a computer of the QA suite is provided with and/or updated with data pertaining to the test, such as one or more test results or effects. In some embodiments, the database is a part of and/or participating in a test management system, so by providing the data pertaining to the test management system is updated.

In some embodiments, a reporting system linked to the QA suite is updated instead of and/or in addition to the database.

Exemplary updates of the database comprise, but not limited to:
Storing of image captured by the camera or a part of the image.
Storing screen images of the mobile device before and after a tilt operation and/or emulation.
Storing determined actual location of the mobile device and location after injecting and/or emulating a GPS location.
Storing a state of the mobile device when the battery level is sufficiently and a corresponding state when a low level of the battery is set and/or emulated.
Storing a caller ID as determined by the mobile device responsive to an emulated call.
Storing an SMS as determined by the mobile device responsive to sending and/or emulation the SMS to the mobile device.
Storing a multimedia message as sent by the mobile device.

In some embodiments, the database is updated responsive to or as a result of a test, so that the tests and updating the database is combined, thereby making the QA suite consistent with the tests of the mobile device.

In operation 208, at least optionally, data in the database in a computer of the QA suite is analyzed.

For example, checking whether responses of the mobile device are as expected and/or to determine what are the differences between the actual responses and the expected ones and/or to determine bugs in the operation of the mobile device, optionally modifying the tests and/or the mobile device such as an application thereof according to the determined differences and/or bugs.

In some embodiments, expected responses are pre-stored in the database and used for comparisons of responses of the mobile device to the tests.

In some embodiments, the response of the mobile device is determined according to emulated or simulated activities. Optionally, the activities are pre-recorded as a sequence captured activities and/or events, such a scenario, which is stored in the database and later on provided to a test program for repeating the sequenced, for example, for checking if the response of the mobile device has changed.

In some embodiments, the database is updated with sequences of data items responsive to repetitions of a test to check and/or analyze evolution of progression of responses to repetitions of the test. For example, a sequence of screen-shots responses to repetitions of the test.

In some embodiments, the database is pre-stored with scenarios of tests, such as a computer code and/or a script of a test which is transferred to the test program for execution. In some embodiments, the scenarios are coded for multiple tests, either immediate and/or scheduled responsive to an operation of an operator. In some embodiments, a scenario is updated and/or changed responsive to the results of the executed scenario. In some embodiments, the database stores additional data related to a test, such as documentation pertaining to a test and/or tested to testable component.

In some embodiments, an operator of the test provides the database additional data such descriptive information, optionally responsive to a test and/or results thereof. In some embodiments, the operator may pick a data from a rendered list or menu or invokes a form which can be filled with data pertaining to the test.

In some embodiments, multiple components of the mobile device are tested and responsive results thereof are stored and/or updated in the database. Optionally, a plurality of components of the mobile device is tested simultaneously and/or in parallel to check effects therebetween.

Thus, in some embodiments, the database stores a set or a suite of a test comprising a scenario and results of the test and, at least optionally, expected results of the test and/or other data that pertains to a test.

In some embodiments, the database is not strictly a database as known in the art, but rather, any storage configured to store and update and retrieve data, optionally according to some conditions such as according to a test and/or component of the mobile device or a ‘ticket’ or ‘docket’ representing a test and other data pertaining to a test.

Below is a procedure that describes, by way of example, an operation of a system such as system 100 illustrated in FIGS. 1B-1C and in view of the outline of FIG. 2 and respective descriptions thereof.

Referring below to a component of the mobile device implies, without limiting any part of the mobile device such as an application operating therein or any resource of the mobile device.

In the context of the procedure below, by way of example, it is assumed that an application operating in the mobile device is tested, such as described above, and a bug such as an inconsistency of a result with respect to an expected result was determined.

The procedure comprises the following exemplary steps.
Invoking by the operator, such as by selecting via a user interface, an appropriate bug reporting utility of the QA suite, such as QA suite 120 or database 124 of QA suite 120.
Selecting by the operator from a list stored on and provided by the database a component that can be reported; that is, the database of the QA suite is configured for storing information pertaining to the respective component.
Selecting by the operator a component to be tested.
Retrieving a status of the mobile device by invoking a service of the probe, such as via an API (e.g. ‘Get DeviceDetails’) responsive to an action of the operator such as clicking on a rendered button. The status of the mobile device includes, for example, device name, OA version, date, time and/or other details such as OS version or location.
Storing the device details in the database such in a structure pertaining to the device and/or testing thereof, optionally adding by the operator additional information vie a presented from of the utility.
The QA suite, such as by the test program, obtains via the probe a list of available and/or accessible components of the mobile device, such as via an API (e.g. ‘BrowseAvailableResources’).
The list is presented, such as by the test program of the QA suite, and the operator selects the requested and/or intended component.
Responsively to selecting the component, the test program via the probe acquires a snapshot of the resource, such as by calling an API (e.g. ‘GetResource’).
Consequently, the snapshot of the component is attached to a structure of the utility of the QA suite.
Possibly after reviewing by the operator the data of the snapshot of the component, the operator invokes a submit operation such as by clicking an appropriate rendered button.
Responsively to submitting the snapshot of the component, the snapshot and related data of the component are stored in the database of the QA suite.
Optionally, further responsively to submitting the snapshot of the component and related data of the component, the snapshot of the component and related data of the component are sent to a bug reporting system.

In some embodiments, the bug reporting system is comprised in the QA suite, for example, by utilizing the database.

In some embodiments, further to the snapshot of the component, a snapshot of the mobile device is acquired by the test program of the QA suite via the probe, such a by invoking a service of the probe by an operator. In some embodiments, the snapshot of the mobile device is submitted along with the snapshot of the component and related data as described above.

There is thus provided according to the present disclosure a computerized method for testing a mobile device, comprising activating in a computer a program that accesses the mobile device via a mechanism that is at least partly installed in the mobile device, thereby conducting a test of the mobile device and consequently acquiring data related to a state of the mobile device, and providing the data related to a state of the mobile device to a storage device of a test management system, thereby updating the test management system.

In some embodiments, the program is communicable with the mechanism that is at least partly installed in the mobile device.

In some embodiments, the mechanism that is at least partly installed in the mobile device is at least partly installed in the computer.

In some embodiments, data for conducting the test of the mobile device is obtained from the storage device of a test management system.

In some embodiments, the test management system operates in a server linked with the computer.

In some embodiments, the data related to a state of the mobile device comprises data related to a state of a component of the mobile device.

In some embodiments, the component of the mobile device comprises at least one of: an application, a storage component, an accelerometer, a camera, GPS, a compass, an inclinometer, or any combination thereof.

There is yet further provided according to the present disclosure a computerized apparatus for testing a mobile device, comprising a computer configured with a program for accessing the mobile device via a mechanism that is at least partly installed in the mobile device, thus facilitating to conduct a test of the mobile device and acquire data related to a state of the mobile device, and a storage device of a test management system linked to the computer, the storage device configured to receive the data related to a state of the mobile device and thereby to update the test management system.

In some embodiments, the storage device is configured for providing data for conducting the test of the mobile device.

In some embodiments, the data related to a state of the mobile device comprises data related to a state of a component of the mobile device.

In some embodiments, the component of the mobile device comprises at least one of: an application, a storage component, an accelerometer, a camera, GPS, a compass, an inclinometer, or any combination thereof.

In the context of some embodiments of the present disclosure, by way of example and without limiting, terms such as ‘operating’ or ‘executing’ imply also capabilities, such as ‘operable’ or ‘executable’, respectively.

The terms ‘processor’ or ‘computer’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable to controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a similar one denotes an apparatus having one or more processors operable or operating according to a program.

The term “configuring” and/or ‘adapting’ for an objective, or a variation thereof, implies using at least a software and/or electronic circuit and/or auxiliary apparatus designed and/or implemented and/or operable or operative to achieve the objective.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated operations may occur in deferent order or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A computerized method for testing a mobile device, comprising:
activating in a computer a program that accesses the mobile device via a mechanism that is at least partly installed in the mobile device, thereby conducting a test of the mobile device and consequently acquiring data related to a state of the mobile device; and
providing the data related to a state of the mobile device to a storage device of a test management system, thereby updating the test management system.

2. The method according to claim 1, wherein the program is communicable with the mechanism that is at least partly installed in the mobile device.

3. The method according to claim 1, wherein the mechanism that is at least partly installed in the mobile device is at least partly installed in the computer.

4. The method according to claim 1, wherein data for conducting the test of the mobile device is obtained from the storage device of a test management system.

6. The method according to claim 1, wherein the test management system operates in a server linked with the computer.

7. The method according to claim 1, wherein the data related to a state of the mobile device comprises data related to a state of a component of the mobile device.

8. The method according to claim 1, wherein the component of the mobile device comprises at least one of: an application, a storage component, an accelerometer, a camera, GPS, a compass, an inclinometer, or any combination thereof.

9. An apparatus for testing a mobile device, comprising:
a computer configured with a program for accessing the mobile device via a mechanism that is at least partly installed in the mobile device, thus facilitating to conduct a test of the mobile device and acquire data related to a state of the mobile device; and
a storage device of a test management system linked to the computer, the storage device configured to receive the data related to a state of the mobile device and thereby to update the test management system.

10. The apparatus according to claim 9, wherein the storage device is configured for providing data for conducting the test of the mobile device.

11. The apparatus according to claim 9, wherein the data related to a state of the mobile device comprises data related to a state of a component of the mobile device.

12. The apparatus according to claim 9, wherein the component of the mobile device comprises at least one of: an application, a storage component, an accelerometer, a camera, GPS, a compass, an inclinometer, or any combination thereof.
